(19) United States
(12) Patent Application Publication
(10) Pub. No.: US 2014/0063355 A1
(43) Pub. Date: Mar. 6, 2014

(54) SPACE POSITIONING METHOD HAVING LIQUID CRYSTAL LENS CAMERA

(71) Applicant: Silicon Touch Technology Inc., Hsin-Chu (TW)

(72) Inventor: Ling-Yuan Tseng, Hsinchu (TW)

(21) Appl. No.: 13/928,320

(22) Filed: Jun. 26, 2013

Related U.S. Application Data
(60) Provisional application No. 61/694,774, filed on Aug. 30, 2012.

(51) Int. Cl. G01B 11/14

(52) U.S. Cl. CPC G01B 11/14
USPC 349/1

(57) ABSTRACT

A space positioning method includes: determining a plurality of distances between an object location of an object in a space and a plurality of different predetermined locations in the space by utilizing a plurality of liquid crystal (LC) lens cameras, respectively, wherein each LC lens camera is located at a predetermined location, and determines a distance between the predetermined location in the space and the object location of the object in the space; and determining a position in space of the object relative to the predetermined locations according to the predetermined locations and the distances.

### CROSS REFERENCE TO RELATED APPLICATIONS

This application claims the benefit of U.S. provisional application No. 61/694,774, filed on Aug. 30, 2012 and incorporated herein by reference.

### BACKGROUND OF THE INVENTION

1. Field of the Invention

The present disclosure relates generally to a space positioning method, and more specifically, to a space positioning method by utilizing liquid crystal lens camera(s) and related space positioning apparatus.

2. Description of the Prior Art

A conventional space position method may use infrared rays or a Global Positioning System (GPS) to determine a position in space. The disadvantage of infrared rays is that they are visible to the human eye. A device with a GPS function has a high resolution and short response time; however, these devices may be extremely costly. Thus, there is a need for a cost-efficient and accurate space position method which can be used in consumer electronics.

### SUMMARY OF THE INVENTION

One of the objectives of the present invention is therefore to provide a space positioning method by utilizing liquid crystal lens camera(s) and related space positioning apparatus.

According to a first aspect of the present invention, an exemplary space positioning method is disclosed. The exemplary space positioning method comprises at least the following steps: determining a plurality of distances between an object location of an object in a space and a plurality of different predetermined locations in the space by utilizing a plurality of liquid crystal (LC) lens cameras, respectively, wherein each LC lens camera is located at a predetermined location, and determines a distance between the predetermined location in the space and the object location of the object in the space; and determining a space position of the object relative to the predetermined locations according to the predetermined locations and the distances.

According to a second aspect of the present invention, an exemplary space positioning method for capturing a holographic image of an object is disclosed. The exemplary space positioning method comprises at least the following steps: capturing a plurality of image frames of the object by utilizing at least one liquid crystal (LC) lens camera located in at least one predetermined location, wherein each LC lens camera captures multiple image frames by using different focal lengths respectively; and obtaining the holographic image of the object according to the image frames captured by the LC lens cameras.

According to a third aspect of the present invention, an exemplary space positioning apparatus is disclosed. The exemplary space positioning apparatus comprises: a plurality of liquid crystal (LC) lens cameras, arranged for determining a plurality of distances between an object location of an object in a space and a plurality of different predetermined locations in the space by utilizing the LC lens cameras, respectively, wherein each LC lens camera is located at a predetermined location, and determines a distance between the predetermined location in the space and the object location of the object in the space; and a processing unit, arranged for determining a space position of the object relative to the predetermined locations according to the predetermined locations and the distances.

According to a fourth aspect of the present invention, an exemplary space positioning apparatus for capturing a holographic image of an object is disclosed. The exemplary space positioning apparatus comprises: at least one liquid crystal (LC) lens camera, located in at least one predetermined location and arranged for capturing a plurality of image frames of the object, wherein each LC lens camera captures multiple image frames by using different focal lengths respectively; and a processing unit, arranged for obtaining the holographic image of the object according to the image frames captured by the LC lens cameras.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an operation of positioning an object in a space by utilizing three liquid crystal (LC) lens cameras.

FIG. 2 is a diagram illustrating a space positioning apparatus according to an embodiment of the present invention.

FIG. 3 is a flowchart illustrating a space positioning method according to an embodiment of the present invention.

FIG. 4 is a diagram illustrating an operation of capturing a holographic image of an object in a space by utilizing a liquid crystal (LC) lens camera from one aspect.

FIG. 5 is a diagram illustrating an operation of capturing a holographic image of an object in a space by utilizing a liquid crystal (LC) lens camera from another aspect.

FIG. 6 is a diagram illustrating an operation of capturing a holographic image of an object in a space by utilizing a liquid crystal (LC) lens camera from yet another aspect.

FIG. 7 is a diagram illustrating a space positioning apparatus for capturing a holographic image of an object according to an embodiment of the present invention.

FIG. 8 is a flowchart illustrating a space positioning method for capturing a holographic image of an object according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

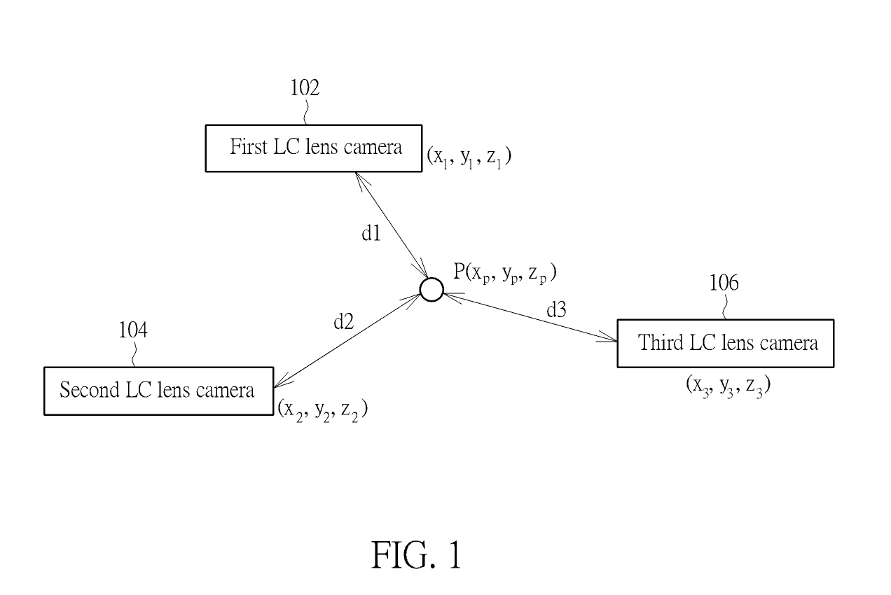

Please refer to FIG. 1, which is a diagram illustrating an operation of positioning an object P in a space by utilizing three liquid crystal (LC) lens cameras. The coordinate of the object P in the three dimensional space is (xₚ, yₚ, zₚ). The coordinate of a first liquid crystal (LC) lens camera 102 is (x₁, y₁, z₁); the coordinate of a second liquid crystal (LC) lens camera 104 is (x₂, y₂, z₂); and the coordinate of a third liquid crystal (LC) lens camera 106 is (x₃, y₃, z₃). It should be noted that the coordinates (x₁, y₁, z₁), (x₂, y₂, z₂), and (x₃, y₃, z₃) are different and should not be arranged in a straight line. The frame with the object P detected (usually in the center of the frame) can be focused onto an image sensor (e.g. a CCD or CMOS sensor) in the LC lens camera. The applied voltage can then be used to obtain the focal length. Depending on the resolution of the image sensor and the circuit design, the focal length measured can be from meters to centimeters or even finer. Detailed descriptions are as follows.

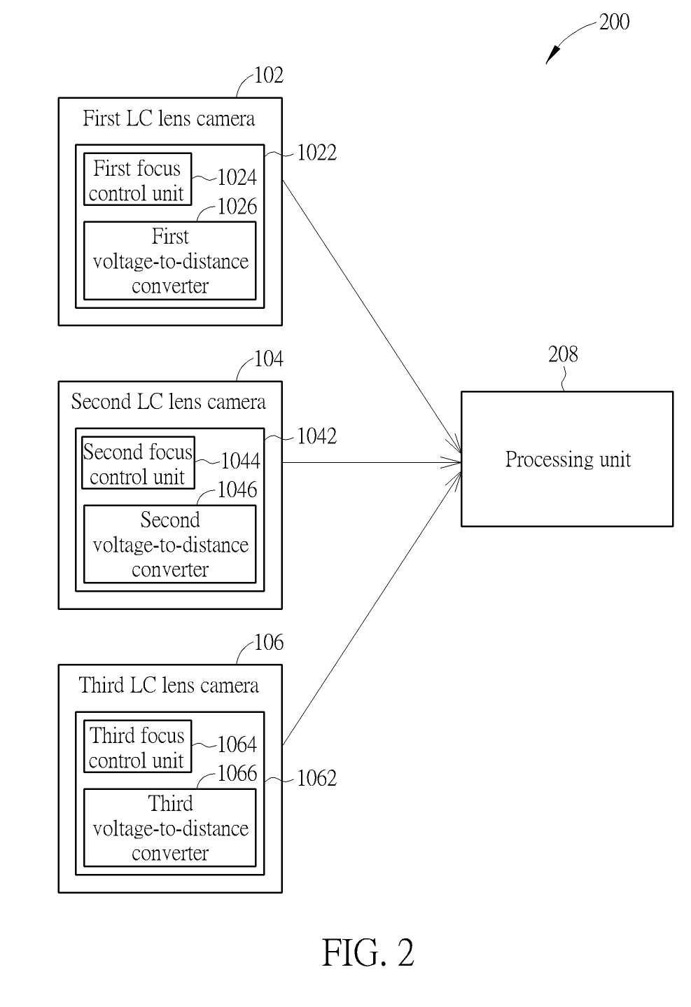

Please refer to FIG. 2, which is a diagram illustrating a space positioning apparatus 200 according to an embodiment of the present invention. The space positioning apparatus 200 includes a processing unit 108 and the aforementioned first LC lens camera 102, second LC lens camera 104, and third LC lens camera 106. The first LC lens camera 102 includes a first distance estimation unit 1022; the second LC lens camera 104 includes a second distance estimation unit 1042; and the third LC lens camera 106 includes a third distance estimation unit 1062.

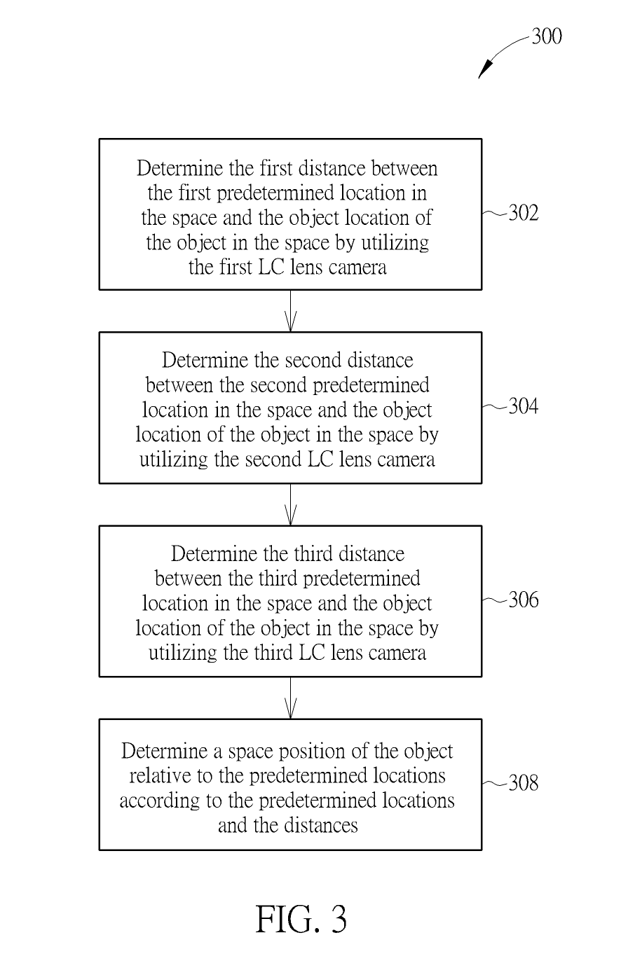

Please refer to FIG. 3 in conjunction with FIGS. 1 and 2. FIG. 3 is a flowchart illustrating a space positioning method 300 according to an embodiment of the present invention. Provided that substantially the same result is achieved, the steps of the flowchart shown in FIG. 3 need not be in the exact order shown and need not be contiguous; that is, other steps can be intermediate. Some steps in FIG. 3 may be omitted according to various embodiments or requirements. The method may be briefly summarized as follows:

Step 302: Determine the first distance between the first predetermined location in the space and the object location of the object in the space by utilizing the first LC lens camera;

Step 304: Determine the second distance between the second predetermined location in the space and the object location of the object in the space by utilizing the second LC lens camera;

Step 306: Determine the third distance between the third predetermined location in the space and the object location of the object in the space by utilizing the third LC lens camera; and

Step 308: Determine a space position of the object relative to the predetermined locations according to the predetermined locations and the distances.

First of all, in step 302, the first LC lens camera 102 uses a first focus control unit 1024 in the first distance estimation unit 1022 to apply a first voltage to allow the first LC lens camera 102 to focus on the object P shown in FIG. 1. Then a focal length d1 may be obtained accordingly by using the first voltage-to-distance converter 1026 in the first distance estimation unit 1022, wherein the first voltage-to-distance converter 1026 obtains the focal length d1 in accordance with a characteristic curve of the first distance estimation unit 1022. The characteristic curve of the first distance estimation unit 1022 is a curve indicative of a voltage-focal length relation. For instance, the x-axis of the characteristic curve indicates the focal length, and the y-axis of the characteristic curve indicates the voltage applied by the first focus control unit 1024. Therefore, the distance between the first LC lens camera 102 and the object P, i.e. the distance d1, is obtained.

In step 304, the second LC lens camera 104 uses a second focus control unit 1044 in the second distance estimation unit 1042 to apply a second voltage to allow the second LC lens camera 104 to focus on the object P shown in FIG. 1. Then, a focal length d2 may be obtained accordingly by using the second voltage-to-distance converter 1046 in the second distance estimation unit 1042, wherein the second voltage-to-distance converter 1046 obtains the focal length d2 in accordance with a characteristic curve of the second distance estimation unit 1042. The characteristic curve of the second distance estimation unit 1042 is a curve indicative of a voltage-focal length relation. For instance, the x-axis of the characteristic curve indicates the focal length, and the y-axis of the characteristic curve indicates the voltage the second focus control unit 1044 applies. Therefore, the distance between the second LC lens camera 104 and the object P, i.e. the distance d2, is obtained.

In step 306, the third LC lens camera 106 uses a third focus control unit 1064 in the third distance estimation unit 1062 to apply a third voltage to allow the third LC lens camera 106 to focus on the object P shown in FIG. 1. Then, a focal length d3 may be obtained accordingly by using the third voltage-to-distance converter 1066 in the third distance estimation unit 1062. The characteristic curve of the third distance estimation unit 1062 is a curve indicative of a voltage-focal length relation. For instance, the x-axis of the characteristic curve indicates the focal length, and the y-axis of the characteristic curve indicates the voltage the third focus control unit 1064 applies. Therefore, the distance between the third LC lens camera 106 and the object P, i.e. the distance d3, is obtained.

After the first distance d1, the second distance d2, and the third distance d3 are obtained, the processing unit 208 is able to determine the position in space of the object P relative to the coordinates of the first, second and third LC lens cameras 102, 104, 106. Through mathematical operations, the coordinate (xₚ, yₚ, zₚ) of the object P can be obtained in according with the coordinates (x₁, y₁, z₁) of the first LC lens camera 102, the coordinates (x₂, y₂, z₂) of the second LC lens camera 104, the coordinates (x₃, y₃, z₃) of the third LC lens camera 106, and the distances d1, d2, and d3. By way of example, conventional mathematical operations may be employed to calculate the coordinates of the object P based on the available information including coordinates of the LC lens cameras and estimated distances. Those persons skilled in the art should readily understand the relevant mathematical operations, and thus the detailed descriptions are omitted here for conciseness.

It should be noted that the disclosed embodiments set forth are for illustrative purposes only, and are not meant to be limitations of the present invention. In other embodiments of the present invention, the number of the LC lens cameras may be different. For example, an alternative design may use 4 LC lens cameras. This also belongs to the scope of the present invention.

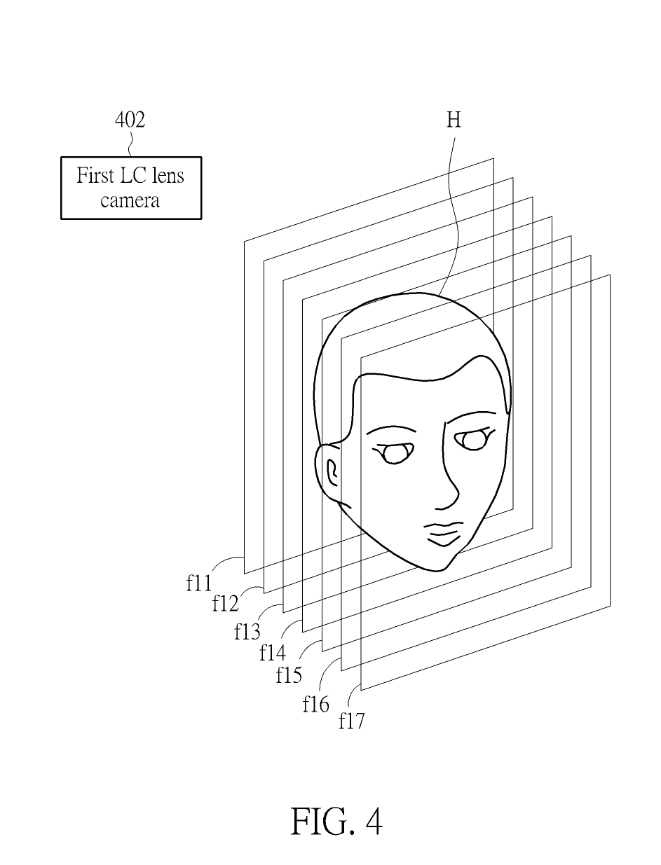

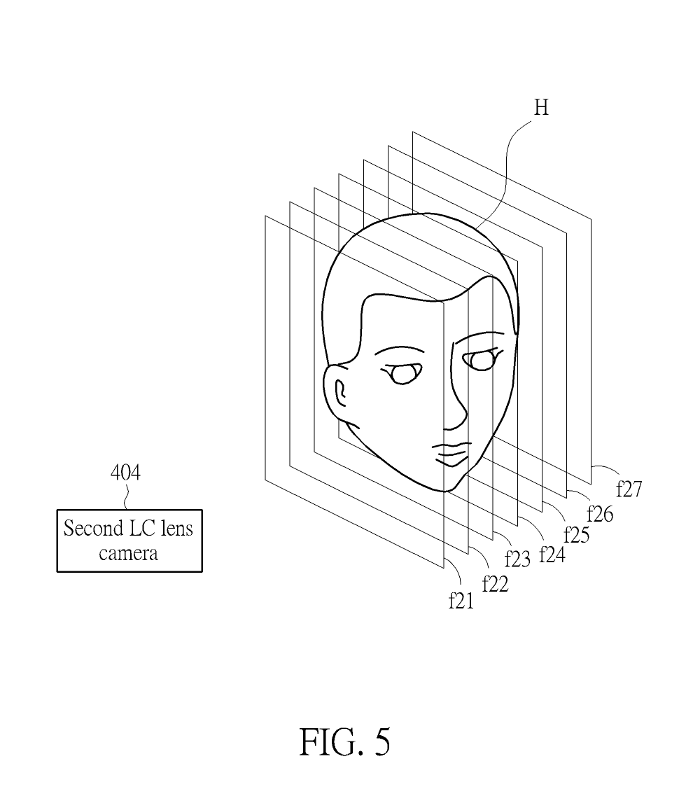

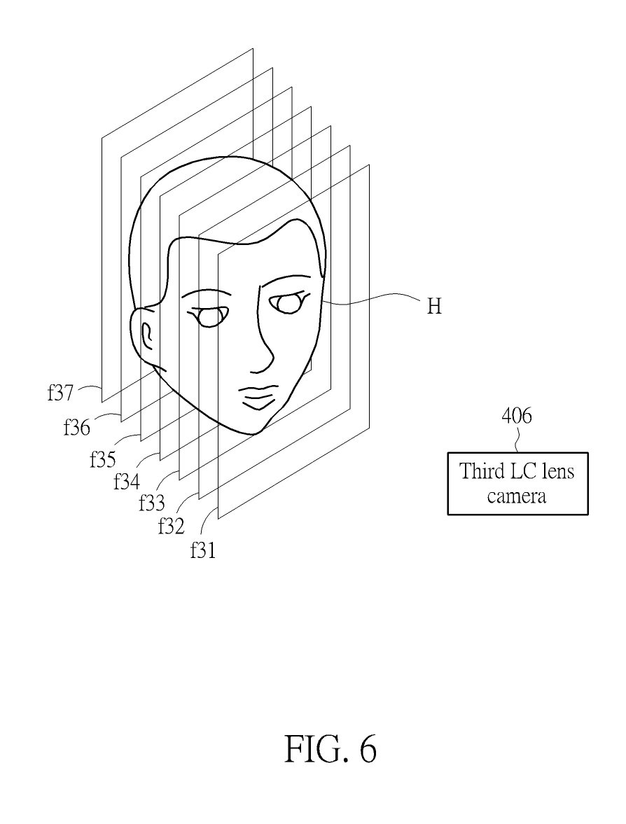

Please refer to FIGS. 4-6, which are diagrams illustrating operations of capturing a holographic image of an object H in a space by utilizing three liquid crystal (LC) lens cameras. In FIG. 4, a first liquid crystal (LC) lens camera 402 captures seven first image frames f11-f17 of the object H with 7 different focal lengths from a location. In FIG. 5, a second liquid crystal (LC) lens camera 404 captures seven first image frames f21-f27 of the object H with 7 different focal lengths from another location. In FIG. 6, a third liquid crystal (LC) lens camera 406 captures seven first image frames f31-f37 of the object H with 7 different focal lengths from still another location. By using different focal lengths, profiles of sections of the same object H from different viewing angles are obtained. Then, the holographic image of the object H can be obtained by putting these profiles together through mathematical operations. Detailed descriptions are as follows.

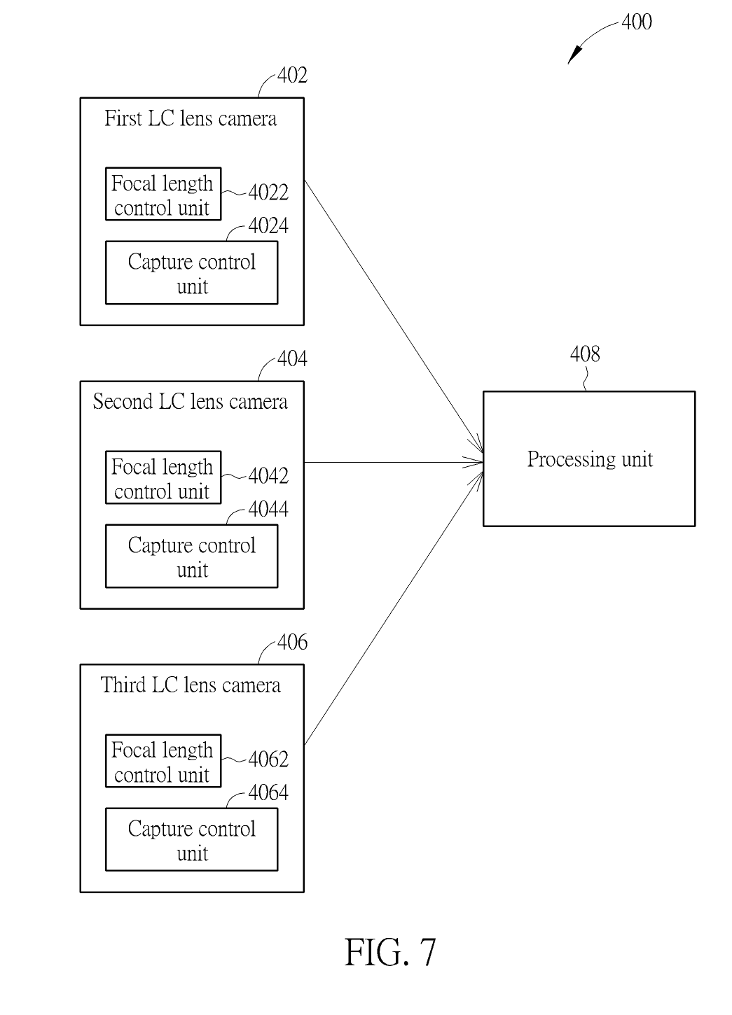

Please refer to FIG. 7, which is a diagram illustrating a space positioning apparatus 400 for capturing a holographic image of an object according to an embodiment of the present invention. The space positioning apparatus 400 includes a processing unit 408 and the aforementioned first LC lens camera 402, second LC lens camera 404, and third LC lens camera 406. The first LC lens camera 402 includes a focal length control unit 4022 and a capture control unit 4024. The focal length control unit 4022 is used for determining a range and intervals of focal lengths applied by the first LC lens camera 402 for capturing the first image frames of the object H. The capture control unit 4024 is used for capturing the first image frames of the object H corresponding to the focal lengths. The second LC lens camera 404 includes a focal length control unit 4042 and a capture control unit 4044. The focal length control unit 4042 is used for determining a range and intervals of focal lengths applied by the second LC lens camera 404 for capturing the second image frames of the object H. The capture control unit 4044 is used for capturing the second image frames of the object H corresponding to the focal lengths. The third LC lens camera 406 includes a focal length control unit 4062 and a capture control unit 4064. The focal length control unit 4062 is used for determining a range and intervals of focal lengths applied by the third LC lens camera 406 for capturing the third image frames of the object H. The capture control unit 4064 is used for capturing the third image frames of the object H corresponding to the focal lengths.

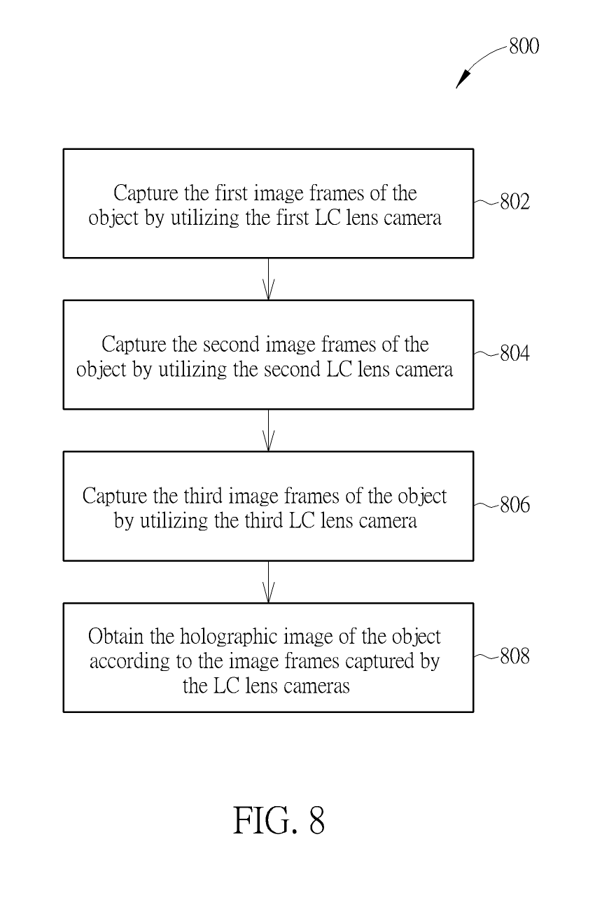

Please refer to FIG. 8 in conjunction with FIGS. 4-7. FIG. 8 is a flowchart illustrating a space positioning method 800 for capturing a holographic image of an object according to an embodiment of the present invention. Provided that substantially the same result is achieved, the steps of the flowchart shown in FIG. 8 need not be in the exact order shown and need not be contiguous; that is, other steps can be intermediate. Some steps in FIG. 8 may be omitted according to various types of embodiments or requirements. The method may be briefly summarized as follows:

Step 802: Capture the first image frames of the object by utilizing the first LC lens camera;

Step 804: Capture the second image frames of the object by utilizing the second LC lens camera;

Step 806: Capture the third image frames of the object by utilizing the third LC lens camera; and

Step 808: Obtain the holographic image of the object according to the image frames captured by the LC lens cameras.

First of all, in Step 802, the first LC lens camera 402 captures the first image frames of the object H. For instance, the focal length control unit 4022 controls the capture control unit 4024 to capture the seven first image frames f11-f17 of the object H, as shown in FIG. 4. To be more specific, the focal length range from the first image frame f11 to the first image frame f17, and the focal length intervals, i.e. the intervals between f11 and f12, f12 and f13, and so on, are determined by the capture control unit 4024. Generally, the focal length range should cover the object H, and the focal length intervals are determined according to a desired resolution.

In Step 804, the second LC lens camera 404 captures the second image frames of the object H. For instance, the focal length control unit 4042 controls the capture control unit 4044 to capture the seven second image frames f21-f27 of the object H, as shown in FIG. 5. To be more specific, the focal length range from the second image frame f21 to the second image frame f27, and the focal length intervals, i.e. the intervals between f21 and f22, f22 and f23, and so on, are determined by the capture control unit 4044. Similarly, the focal length range should cover the object H, and the focal length intervals are determined according to a desired resolution.

In Step 806, the third LC lens camera 406 captures the third image frames of the object H. For instance, the focal length control unit 4062 controls the capture control unit 4064 to capture the seven third image frames f31-f37 of the object H, as shown in FIG. 6. To be more specific, the focal length range from the third image frame f31 to the second image frame f37, and the focal length intervals, i.e. the intervals between f31 and f32, f32 and f33, and so on, are determined by the capture control unit 4064. Similarly, the focal length range should cover the object H, and the focal length intervals are determined according to a desired resolution.

After the first images f11-f17, the second images f21-f27, and the third images f31-f37 are obtained, the processing unit 408 is therefore able to compute the holographic image of the object H. Since profiles of sections of the object H from different points of view are obtained, the holographic image of the object H can be re-constructed by stitching these profiles together through mathematical operations. By way of example, conventional mathematical operations may be employed to create the holographic image of the object H based on the available information including the images captured at different viewing angles. Those person skilled in the art should readily understand the relevant mathematical operations, and thus the detailed descriptions are omitted here for conciseness.

It should be noted that the disclosed embodiments set forth are for illustrative purposes only, and are not meant to be limitations of the present invention. In other embodiments of the present invention, the number of the LC lens cameras may be different. For example, an alternative design may use 4 LC lens cameras. In some other cases, the LC lens cameras may move around the object to have a full image without dead angles, or the object may itself rotate. In such cases, only one LC lens camera is needed to obtain images with full coverage of the object.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A space positioning method, comprising:
determining a plurality of distances between an object location of an object in a space and a plurality of different predetermined locations in the space by utilizing a plurality of liquid crystal (LC) lens cameras, respectively, wherein each LC lens camera is located at a predetermined location, and determines a distance between the predetermined location in the space and the object location of the object in the space; and
determining a position in space of the object relative to the predetermined locations according to the predetermined locations and the distances.

2. The space positioning method of claim 1, wherein the LC lens cameras include a first LC lens camera located at a first predetermined location, a second LC lens camera located at a second predetermined location, and a third LC lens camera located at a third predetermined location; the distances include a first distance, a second distance and a third distance; and the step of determining the distances comprises:
determining the first distance between the first predetermined location in the space and the object location of the object in the space by utilizing the first LC lens camera;
determining the second distance between the second predetermined location in the space and the object location by utilizing the second LC lens camera; and
determining the third distance between the third predetermined location in the space and the object location by utilizing the third LC lens camera.

3. The space positioning method of claim 2, wherein the step of determining the first distance between the first predetermined location in the space and the object location of the object in the space by utilizing the first LC lens camera comprises:
obtaining a first voltage applied by the first LC lens camera for focusing on the object; and
converting the first voltage to the first distance through a voltage-focus distance curve of the first LC lens camera.

4. The space positioning method of claim 2, wherein the step of determining the second distance between the second predetermined location in the space and the object location of the object in the space by utilizing the second LC lens camera comprises:
obtaining a second voltage applied by the second LC lens camera for focusing on the object; and
converting the second voltage to the second distance through a voltage-focus distance curve of the second LC lens camera.

5. The space positioning method of claim 2, wherein the step of determining the third distance between the third predetermined location in the space and the object location of the object in the space by utilizing the third LC lens camera comprises:
obtaining a third voltage applied by the third LC lens camera for focusing on the object; and
converting the third voltage to the third distance through a voltage-focus distance curve of the third LC lens camera.

6. A space positioning method for capturing a holographic image of an object, comprising:
capturing a plurality of image frames of the object by utilizing at least one liquid crystal (LC) lens camera located in at least one predetermined location, wherein each LC lens camera captures multiple image frames by using different focal lengths respectively; and
obtaining the holographic image of the object according to the image frames captured by the LC lens cameras.

7. The space positioning method of claim 6, wherein the LC lens camera includes a first LC lens camera located at a first predetermined location, a second LC lens camera located at a second predetermined location, and a third LC lens camera located at a third predetermined location; the image frames captured by the LC lens cameras include a plurality of first image frames, a plurality of second image frames, and a plurality of third image frames; and the step of capturing the image frames of the object comprises:
capturing the first image frames of the object by utilizing the first LC lens camera;
capturing the second image frames of the object by utilizing the second LC lens camera; and
capturing the third image frames of the object by utilizing the third LC lens camera.

8. The space positioning method of claim 7, wherein the step of capturing the first image frames of the object by utilizing the first LC lens camera comprises:
determining a range and intervals of focal lengths applied by the first LC lens camera for capturing the first image frames of the object; and
capturing the first image frames of the object corresponding to the focal lengths.

9. The space positioning method of claim 7, wherein the step of capturing the second image frames of the object by utilizing the second LC lens camera comprises:
determining a range and intervals of focal lengths applied by the second LC lens camera for capturing the second image frames of the object; and
capturing the second image frames of the object corresponding to the focal lengths.

10. The space positioning method of claim 7, wherein the step of capturing the third image frames of the object by utilizing the third LC lens camera comprises:
determining a range and intervals of focal lengths applied by the third LC lens camera for capturing the third image frames of the object; and
capturing the third image frames of the object corresponding to the focal lengths.

11. A space positioning apparatus, comprising:
a plurality of liquid crystal (LC) lens cameras, arranged for determining a plurality of distances between an object location of an object in a space and a plurality of different predetermined locations in the space by utilizing the LC lens cameras, respectively, wherein each LC lens camera is located at a predetermined location, and determines a distance between the predetermined location in the space and the object location of the object in the space; and
a processing unit, arranged for determining a position in space of the object relative to the predetermined locations according to the predetermined locations and the distances.

12. The space positioning apparatus of claim 11, wherein the LC lens cameras include a first LC lens camera located at a first predetermined location, a second LC lens camera located at a second predetermined location, and a third LC lens camera located at a third predetermined location; the distances include a first distance, a second distance and a third distance; and the first LC lens camera comprises a first distance estimation unit, arranged for determining the first distance between the first predetermined location in the space and the object location of the object in the space by utilizing the first LC lens camera; the second LC lens camera comprises a second distance estimation unit, arranged for determining the second distance between the second predetermined location in the space and the object location by utilizing the second LC lens camera; and the third LC lens camera comprises a third distance estimation unit, arranged for determining the third distance between the third predetermined location in the space and the object location by utilizing the third LC lens camera.

13. The space positioning apparatus of claim 12, wherein the first distance estimation unit comprises:
a first focus control unit, arranged for obtaining a first voltage applied by the first LC lens camera for focusing on the object; and
a first voltage-to-distance converter, arranged for converting the first voltage to the first distance through a voltage-focus distance curve of the first LC lens camera.

14. The space positioning apparatus of claim 12, wherein the second distance estimation unit comprises:
a second focus control unit, arranged for obtaining a second voltage applied by the second LC lens camera for focusing on the object; and
a second voltage-to-distance converter, arranged for converting the second voltage to the second distance through a voltage-focus distance curve of the second LC lens camera.

15. The space positioning apparatus of claim 12, wherein the third distance estimation unit comprises:
a third focus control unit, arranged for obtaining a third voltage applied by the third LC lens camera for focusing on the object; and
a third voltage-to-distance converter, arranged for converting the third voltage to the third distance through a voltage-focus distance curve of the third LC lens camera.

16. A space positioning apparatus for capturing a holographic image of an object, comprising:
at least one liquid crystal (LC) lens cameras, located in at least one predetermined location and arranged for capturing a plurality of image frames of the object, wherein each LC lens camera captures multiple image frames by using different focal lengths respectively; and
a processing unit, arranged for obtaining the holographic image of the object according to the image frames captured by the LC lens cameras.

17. The space positioning apparatus of claim 16, wherein the at least one LC lens camera comprises:
a first LC lens camera, arranged for capturing a plurality of first image frames of the object;
a second LC lens camera, arranged for capturing a plurality of second image frames of the object; and
a third LC lens camera, arranged for capturing a plurality of third image frames of the object.

18. The space positioning apparatus of claim 17, wherein the first LC lens camera comprises:
a focal length control unit, arranged for determining a range and intervals of focal lengths applied by the first LC lens camera for capturing the first image frames of the object; and
a capture control unit, arranged for capturing the first image frames of the object corresponding to the focal lengths.

19. The space positioning apparatus of claim 17, wherein the second LC lens camera comprises:
a focal length control unit, arranged for determining a range and intervals of focal lengths applied by the second LC lens camera for capturing the second image frames of the object; and
a capture control unit, arranged for capturing the second image frames of the object corresponding to the focal lengths.

20. The space positioning apparatus of claim 17, wherein the third LC lens camera comprises:
a focal length control unit, arranged for determining a range and intervals of focal lengths applied by the third LC lens camera for capturing the third image frames of the object; and
a capture control unit, arranged for capturing the third image frames of the object corresponding to the focal lengths.
